(19) United States
(12) Patent Application Publication
(10) Pub. No.: US 2006/0211449 A1
(43) Pub. Date: Sep. 21, 2006

(54) Reconfigurable wireless interconnects for data communication

(75) Inventors: Jamal Haque, Tampa, FL (US); Jeremy Ramos, Clearwater, FL (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., MORRISTOWN, NJ (US)

(21) Appl. No.: 11/083,520

(22) Filed: Mar. 18, 2005

(51) Int. Cl. H04M 1/00

(52) U.S. Cl. 455/556.1

(57) ABSTRACT

Systems and methods for reconfigurable wireless interconnects for data communication are provided. A computer system comprises a plurality of processing elements and one or more reconfigurable wireless interconnects. Each processing element is adapted to communicate data to at least on other processing element through the one or more reconfigurable wireless interconnects.

### TECHNICAL FIELD

The following description relates generally to computer system design and more specifically to reconfigurable wireless interconnects for data communication.

### BACKGROUND

Space satellites are typically launched for the purpose of performing specific missions (e.g. communication, navigation, reconnaissance, and scientific research). However, because the specific needs of satellite owners change over time, and because of the appreciable costs associated with launching new satellites, reconfigurable spacecraft are highly desirable to provide the most flexibility in the use of a satellite already in space. One current limitation affecting reconfigurability of satellites lies in the design of computer processing components that rely on wires, or printed circuit board wiring traces, to provide for the interconnection of processing components. High speed data transfer between chip level components in computer processing systems is currently accomplished through printed circuit board wiring traces that connect the input/output (I/O) pin interfaces of one component chip to the I/O pin interfaces of another. These chip level interconnections require circuit board layouts to connect data buses and address buses between system components through conducting metallic traces. Such hardware level interconnections limit the flexability of satellites because the data flow paths between components cannot be altered as required to meet the processing needs of changing missions. Additionally, reliance on hardwired interconnections between components leaves the system vulnerable to complete or partial system failure due to the failure of a single component.

For the reasons stated above and for other reasons stated below which will become apparent to those skilled in the art upon reading and understanding the present specification, there is a need in the art for reconfigurable interconnections between satellite processing systems components.

### SUMMARY

The embodiments of the present invention provide systems and methods for reconfigurable wireless interconnects for data communication, and will be understood by reading and studying the following specification.

In one embodiment, a reconfigurable computer processing system is provided. The system comprises a plurality of processing elements and one or more reconfigurable wireless interconnects. Each processing element is adapted to communicate to at least one other processing element through the one or more reconfigurable wireless interconnects.

In another embodiment, a reconfigurable processing system is provided. The system comprises two or more means for processing data and one or more means for reconfigurable wireless interconnection, wherein the two or more means for processing data communicate through the one or more means for reconfigurable wireless interconnections.

In yet another embodiment, a method for wireless data communication between processing elements is provided. The method comprises modulating processing element data output and demodulating the processing element data input. The method further comprises transmitting one or more RF signals representing processing data output at a first data bit rate and receiving one or more RF signals representing processing data input at a second data bit rate.

In still yet another embodiment, a processing element adapted to communicate to at least one other processing element through one or more reconfigurable wireless interconnects is provided. The processing element comprises one or more micro-antennas and one or more radio transmitter modules adapted to transmit one or more RF signals representing processing element data output. The one or more radio transmitter modules are further adapted to modulate the processing element data output based on a first data link protocol. The processing element further comprises one or more radio receiver modules adapted to receive one or more RF signals representing processing element data input. The one or more radio receiver modules are further adapted to demodulate the processing element data input based on a second data link protocol.

### DRAWINGS

The present invention can be more easily understood and further advantages and uses thereof more readily apparent when considered in view of the detailed description and the following figures in which:

FIG. 1A is a block diagram illustrating a processing system having reconfigurable wireless interconnections for data communications of one embodiment of the present invention;

FIG. 1B is a block diagram illustrating a configuration control channel for reconfigurable wireless interconnections of one embodiment of the present invention;

FIG. 2 is a block diagram illustrating a reconfigurable wireless interconnection enabled processing element of one embodiment of the present invention;

FIG. 3A is a block diagram illustrating an omni-directional RF signal transmission of one embodiment of the present invention;

FIG. 3B is a block diagram illustrating directional RF signal transmissions of one embodiment of the present invention;

FIGS. 4A and 4B are block diagrams illustrating a micro-antenna array for a reconfigurable wireless interconnection enabled processing element of one embodiment of the present invention; and

FIG. 5 is a flow chart illustrating a method of one embodiment of the present invention.

In accordance with common practice, the various described features are not drawn to scale but are drawn to emphasize features relevant to the present invention. Reference characters denote like elements throughout Figures and text.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

Reconfigurable spacecraft is an emerging space system concept that provides an advancement in the ability to do more with space based resources. Morphable spacecraft facilitate the implementation of adaptable missions that change with user needs. By providing flexible and high performance computing resources harmonious with the concept of reconfigurable spacecraft, reconfigurable computing systems of embodiments of the present invention provide many benefits to space systems. Reducing rigid wired interconnection constraints is one solution to harnessing the full potential of reconfigurable systems. Embodiments of the present invention provide reconfigurable wireless interconnects (RWIs) as a replacement for physical inter-subsystem, inter-board, and inter-chip interconnections. RWIs abate the reliance on wires and printed circuit board traces. In addition, with the elimination of hardwired connections between components, chip designers will no longer need to allocate power or space to facilitate I/O pins.

In the past decade significant advancements have been made in wireless technology used in data-communication and telecommunication networks. The integration of radios into a single device and the development of nanocomputer networks have paved the way for RWI.

Embodiments of the present invention provide systems and methods that eliminate the need for the physical interconnection of components by integrating wireless communication interfaces into individual components. Embodiments of the present invention integrate radio transmitters and receivers into the processing chip in place of traditional I/O pins. By utilizing wireless data communications technology, embodiments of the present invention provide high speed, short range, robust, bandwidth adaptive wireless data links between system components.

Embodiments of the present invention provide flexibility for reprogramming remote systems, such as systems embedded in satellites in space, where physical alterations to the systems configuration is all but impossible.

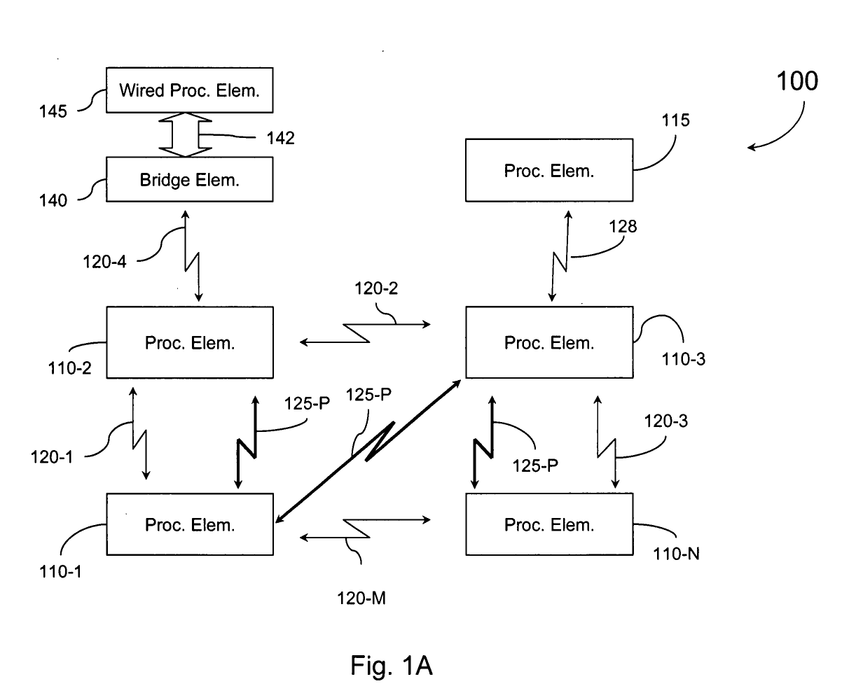

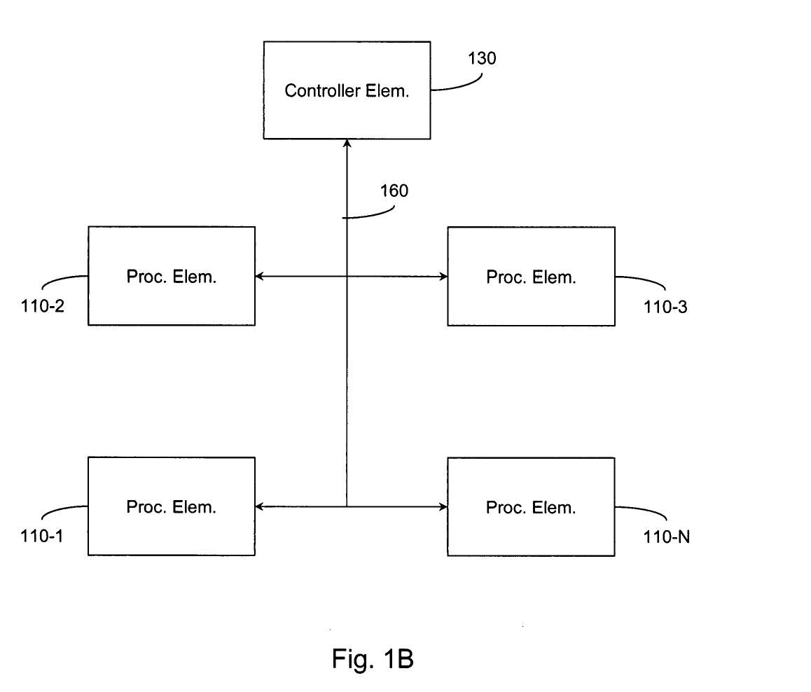

FIG. 1A illustrates a processing system 100 having RWIs of one embodiment of the present invention. Processing system 100 comprises a plurality of processing elements 110-1 to 110-N communicating with each other over one or more RWIs 120-1 to 120-M. Processing element 110-1 to 110-N include those devices that normally send processing data output to other system components, and receive processing data input from other system components, through one or more hardwired bus connection. In one embodiment, processing elements 110-1 to 110-N include one or more of, but not limited to micro-processors, memory, digital signal processors, math co-processors, field-programmable gate arrays (FPGA), analog-to-digital (A/D) and digital-to-analog (D/A) converters.

In one embodiment, processing elements 110-1 to 110-N are initially configured by design engineers to communicate with each other via RWIs 120-1 to 120-M based on the initial mission requirements of system 100. When mission requirements change, embodiments of the present invention allow reconfiguration of system 100 without the necessity of re-routing printed circuit board wiring traces. Instead, one or more of processing elements 110-1 to 110-N are reprogrammed to discontinue one or more of RWIs 120-1 to 120-M and establish one or more of RWIs 125-1 to 125-P.

In another embodiment, the present invention facilitates the mitigation of component failures. In one embodiment, two or more of processing elements 110-1 to 110-N are FPGAs. In one embodiment, repair of system 100 is accomplished by reprogramming the logic of one FPGA to perform the needed functions of a failed FPGA. Then one or more of RWIs 120-1 to 120-M and RWIs 125-1 to 125-P are respectively discontinued and established to reroute data communication from the failed FPGA to the reprogrammed FPGA. As would be appreciated by one skilled in the art upon reading this specification, mitigation of component failures is not limited to embodiments where processing elements 110-1 to 110-N are FPGAs. In general, if another processing element 110-1 to 110-N in the network has the necessary resources to perform a failed device's functions, it may replace the failed device in the network.

In operation, in one embodiment, when a first processing element 110-1 has generated or otherwise prepared data for output (i.e. processing data output), the data is transmitted to the intended recipient, such as a second processing element 110-2 through RWI 120-1. In this way, embodiments of the present invention eliminate the need for wired address and data buses. As an example, in one embodiment, processing element 110-2 is a memory device and processing element 110-1 is an FPGA. In one embodiment, FPGA 110-1 outputs processing data output to memory device 110-2, via RWI 120-1, including instructions to store data in a specified memory address. Accordingly, memory device 110-2 receives the data (as processing data input) and stores the data as instructed by FPGA 110-1. In another embodiment, a plurality of processing elements 110-1 to 110-N are FPGAs receiving processing data input from each other via one or more RWIs 120-1 to 120-M and sending processing data output to each other via one or more RWIs 120-1 to 120-M

In another embodiment, the present invention facilitates system expansion for system 100. In one embodiment, system 100 expansion is accomplished by bringing another RWI enabled processing element, such as processing element 115 within communications range of one or more of processing elements 110-1 to 110-N. Then, one or more of processing elements 110-1 to 110-N are reprogrammed to establish one or more of RWIs 128. In one embodiment, processing element 155 is a built in spare device. In another embodiment, processing element 115 is physically located remotely, for example in a nearby spacecraft brought into communications range with one or more of processing elements 110-1 to 110-N. In one embodiment, system 100 further comprises one or more bridge elements 140 which are adapted to communicate via one or more of RWIs 120-1 to 120-N with one or more processing elements 110-1 to 110-N. Bridge elements 140 are further adapted to communicate with one or more hardwired data busses 142 in order to bridge data communications between wired processing elements 145 and processing elements 110-1 to 110-N.

In one embodiment of the present invention, the reconfiguration of RWIs is accomplished through a control channel 160 as illustrated in FIG. 1B. In one embodiment, control channel 160 is a wired interface connected to each of processing elements 110-1 to 110-N and a controller element 130. In one embodiment, control channel 160 is one of, but not limited to, a serial bus, a parallel data bus, a fiber optic channel, and a wireless communications channel (such as an RWI). In one embodiment, controller element 130 configures each of processing elements 110-1 to 110-N to know which of the other processing elements 110-1 to 110-N to transmit to and which of the other processing elements 110-1 to 110-N to listen to. In one embodiment, control channel 160 is established via one or more RWIs through which controller element 130 broadcasts configuration information to processing elements 110-1 to 110-N.

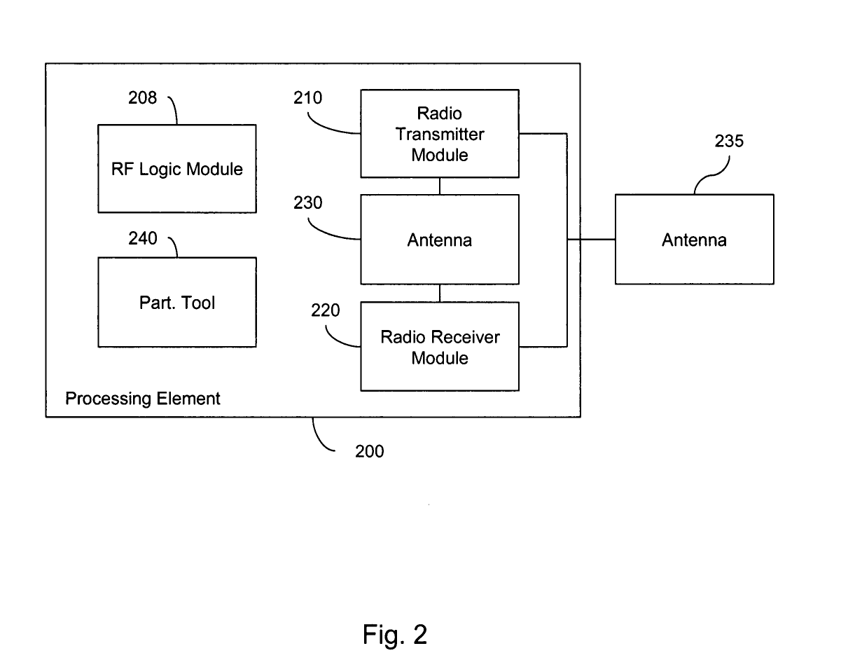

FIG. 2 illustrates one embodiment of a RWI enabled processing element 200. Processing element 200 comprises one or more radio transmitter modules 210, one or more radio receiver modules 220, and one or more antennas 230. In one embodiment, one or more antennas 235, external to processing element 200, are coupled to one or more of radio transmitter modules 210 and radio receiver modules 220. In one embodiment, each radio transmitter module 210, and radio receiver module 220, are comprised of integrated analog components including one or more of amplifiers, filters, A/D converters and D/A converters. In one embodiment, processing element further comprises a logic module 208 adapted implement one or more data link protocols in order to establish one or more RWIs. In one embodiment, one or more radio transmitter modules 210 and one or more radio receiver modules 220 are integrated into one or more transceiver modules. In one embodiment, one or more radio transmitter modules 210 and one or more radio receiver modules 220 are physically integrated into the logic of processing element 200.

Data rates approaching many gigabits per second are possible with existing RF technology and the power consumption for such systems is decreasing abreast the miniaturization of transceivers. Moreover, bit error rates of less than 10⁻⁶ have been demonstrated using RF over hundreds of meters. By employing modern RF modulation and channel multiplexing techniques including, but not limited to orthogonal frequency division multiplexing (OFDM), Multiple Input, Multiple Output (MIMO) transceiver, code-division multiple access (CDMA), and Ultra Wide Band (UWB), embodiment of the present invention enable processing elements to establish RWIs with little interference between channels and other systems.

In one embodiment, the one or more radio transmitter modules 210 and one or more radio receiver modules 220 are ultra wide band (UWB) radio modules. UWB wireless technology is preferred because UWB 1) allows high data exchange rates at close proximity, 2) requires very low power to transmit at close ranges, 3) is robust and resistant to multi-path interference, and 4) can be achieved through simple transmitter and receiver realizations. As would be appreciated by one skilled in the art upon reading this specification, the integration of such UWB radio transmitter and receiver modules onto chip devices is realizable with existing integrated circuit manufacturing technology. In one embodiment, radio transmitter modules 210 and radio receiver modules 220 are physically integrated into the logic layer of an integrated chip device, such as an FPGA. On one embodiment, radio transmitter modules 210 and radio receiver modules 220 are stacked onto the logic layer of an integrated chip device and housed inside the same I/C device package.

In one embodiment, RF logic module 208 is adapted to digitally re-configure radio modules 210 and 220 to implement different data link protocols. In one embodiment, before processing element 200 transmits processing data output via an RWI, high level algorithm system partitioning tool 240 analyzes the data and determines the needed data through-put. In one embodiment RF logic module 208 configures the RWI for effective use of bandwidth based on the needed data through-put. For example, in one embodiment a first processing element may only require 500 kb of bandwidth to communicate processing data output with a second processing element. In one embodiment, partitioning tool 240 accordingly configures an RWI between the first and second processing element for 500 kb of bandwidth. In contrast, 500 Mb of bandwidth could be necessary when the first processing element communicates processing data output with a third processing element. In that case, partitioning tool 240 configures an RWI between the first and third processing element for 500 Mb of bandwidth.

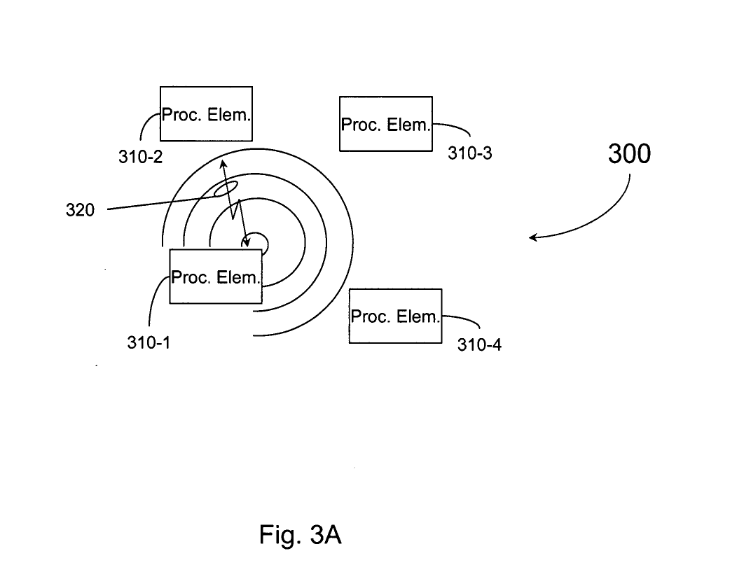

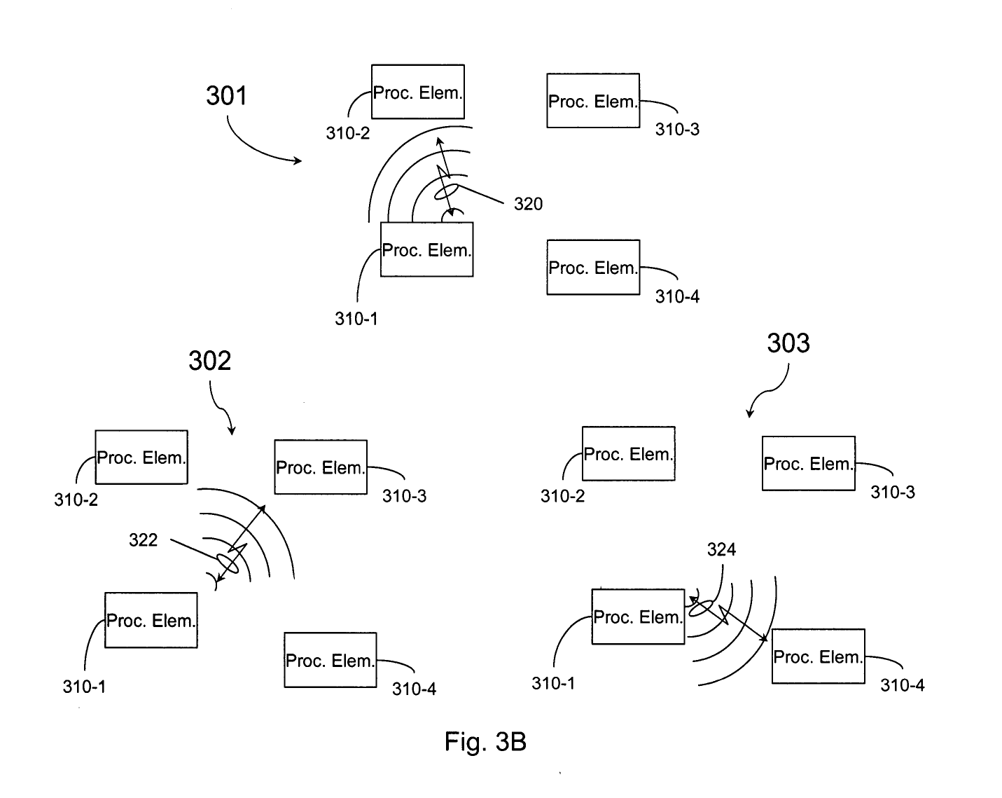

FIGS. 3A and 3B illustrate one or more RWIs of the present invention established through either omni-directional RF transmissions 300, or directional RF transmissions 301, 302 and 303. FIG. 3A illustrates RWI 320 established by an omni-directional RF signal transmitted from processing element 310-1 and received by processing element 310-2. Unintended recipients of the RF signal (i.e. the other processing elements 310-3 through 310-4) are adapted to ignore the RF signal. However, there is no need to transmit omni-directional RF energy when processing element 310-1 needs to establish RWI 320 with processing element 310-2. Instead as illustrated in FIG. 1B, in one embodiment, processing element 310-1 focuses RF energy only in the direction of processing element 310-2. Similarly, when processing element 310-1 needs to establish RWI 322 with processing element 310-3, or RWI 324 with processing element 310-4, it focuses RF energy only in the direction of processing element 310-3 or processing element 310-4, respectively.

One skilled in the art upon reading this specification would appreciate that a beam forming micro-antenna array can be formed by transmitting an RF signal from a plurality of micro-antennas and individually adjusting the signal gain and phase angle of the RF signal transmitted by each micro-antenna of the plurality of micro-antennas. Beam formation allows the efficient control of radio waves towards a directed area of a system or specific receiving processing elements. Beam forming also results in reduced power consumption and reduces potential interference between other wireless processing elements as RF energy is directed only to the intended receiving processing element.

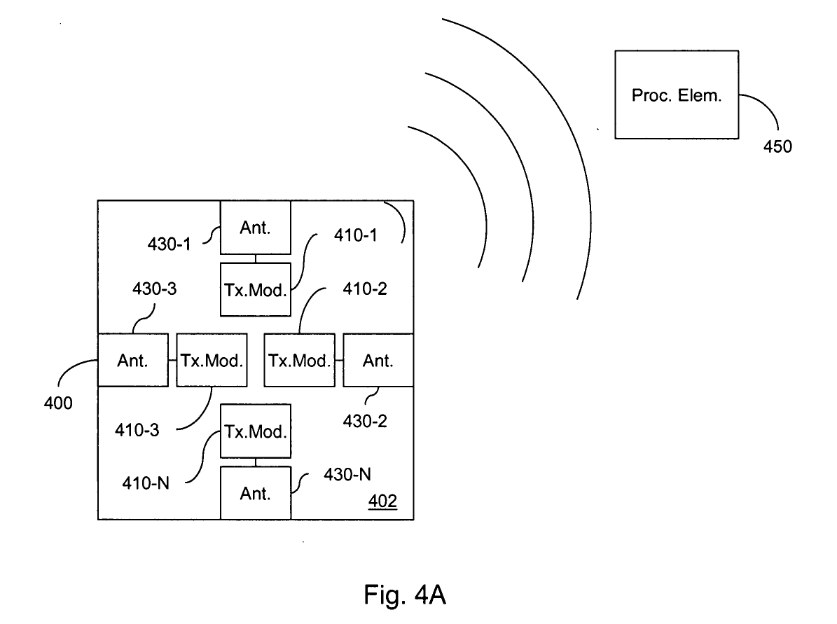

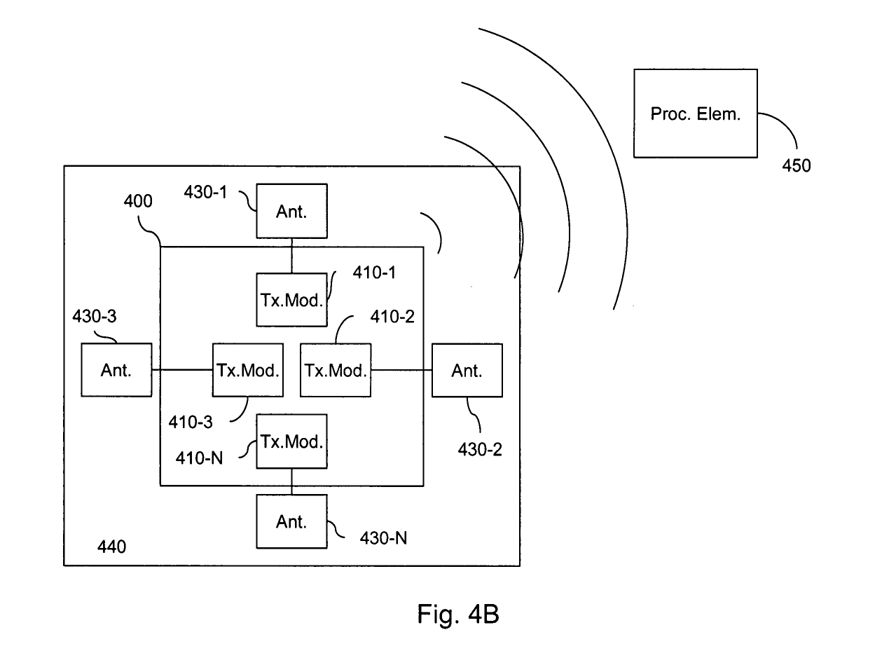

As illustrated in FIG. 4A, in one embodiment, processing element 400 includes a plurality of transmitter modules 410-1 to 410-N, and a plurality of micro-antennas 430-1 to 430-N, wherein each transmitter module 410-1 to 410-N is coupled to transmit through one of micro-antennas 430-1 to 430-N. In operation, a directional RF signal beam is formed and pointed in the direction of a receiving processing element 450 by adjusting the signal gain and relative phase angle of the RF signal transmitted by each of micro-antennas 430-1 to 430-N.

In one embodiment, one or more of the plurality of micro-antennas 430-1 to 430-N are integrated into the I/C chip package housing 402 of processing element 400. As illustrated in FIG. 4B, in one embodiment, one or more of the plurality of micro-antennas 430-1 to 430-N are integrated into a printed circuit board on which processing element 400 is mounted. In one embodiment, one or more of the plurality of micro-antennas 430-1 to 430-N are coupled to transmitter modules 410-1 to 410-N via one or more I/O pins.

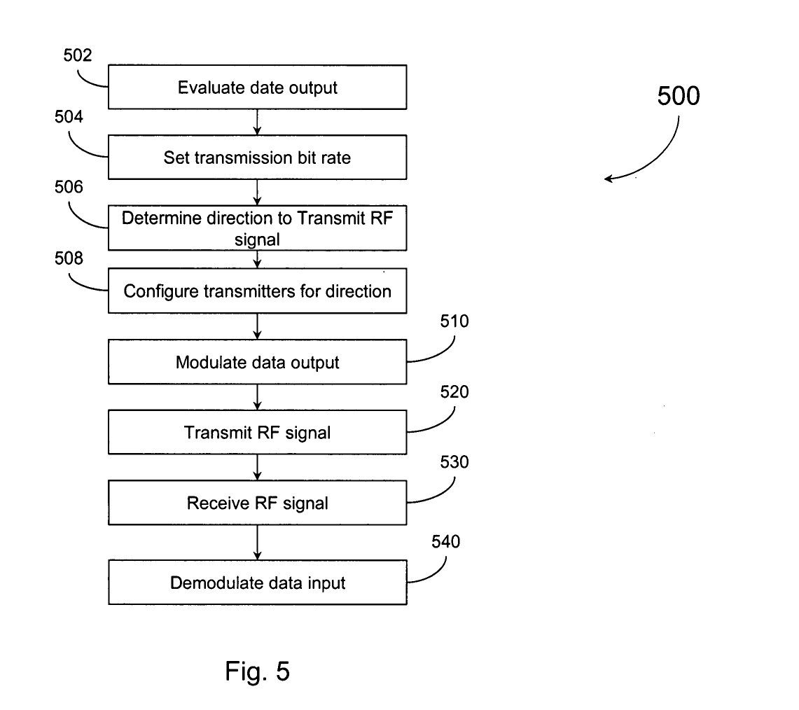

FIG. 5 provides a flow chart illustrating a method 500 for wireless data communication between processing elements of one embodiment of the present invention. The method comprises modulating processing element data output (510), transmitting one or more RF signals representing processing data output at a first data bit rate (520), receiving one or more RF signals representing processing data input (530) and demodulating processing element data input (540). In one embodiment, the processing elements include one or more of micro-processors, memory, digital signal processors, math co-processors, field-programmable gate arrays (FPGA), analog-to-digital (A/D) and digital-to-analog (D/A) converters, or other devices that typically send processing data output to other system components, and receive processing data input from other system components, through one or more hardwired bus connection. In another embodiment, the method further comprises evaluating processing element data output to determine the first bit rate (502) and configuring a radio transmitter to the first bit rate (504). In another embodiment, the method further comprises determining a direction to transmit an RF signal (506) and configuring transmitters to transmit an RF signal in the determined direction (508).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A reconfigurable computer processing system, the system comprising:
a plurality of processing elements, and
one or more reconfigurable wireless interconnects, wherein each processing element is adapted to communicate to at least one other processing element through the one or more reconfigurable wireless interconnects.

2. The system of claim 1, wherein the plurality of processing elements include at least one of micro-processors, memory, digital signal processors, math co-processors, field-programmable gate arrays (FPGA), analog-to-digital (A/D) and digital-to-analog (D/A) converters.

3. The system of claim 1, wherein each processing element of the plurality of processing elements further comprises:
one or more micro-antennas;
one or more radio transmitter modules adapted to transmit one or more RF signals representing processing element data output, wherein the one or more radio transmitter modules are further adapted to modulate the processing element data output based on a first data link protocol; and
one or more radio receiver modules adapted to receive one or more RF signals representing processing element data input, wherein the one or more radio receiver modules are further adapted to demodulate the processing element data input based on a second data link protocol.

4. The system of claim 3, wherein the plurality of processing elements include one or more of micro-processors, memory, digital signal processors, math co-processors, field-programmable gate arrays (FPGA), analog-to-digital (A/D) and digital-to-analog (D/A) converters.

5. The system of claim 3, wherein the first data link protocol and the second data link protocol each include one or more of a data link bit-rate and a modulation protocol.

6. The system of claim 5, wherein the modulation protocol is one of orthogonal frequency division multiplexing (OFDM), code-division multiple access (CDMA), and ultra wide band (UWB).

7. The system of claim 5, wherein each processing element of the plurality of processing elements further comprises:
a partitioning tool, wherein the partitioning tool is adapted to evaluate the processing element data output to determine the required data link bit-rate.

8. The system of claim 3, wherein each processing element of the plurality of processing elements comprises:
at least two micro-antennas; and
at least two radio transmitter modules coupled to transmit through the at least two micro-antennas, wherein each radio transmitter module of the at least two radio transmitter modules are adapted to transmit an RF signal representing processing element data output, wherein the processing element is further adapted to control the direction of the RF signal transmitted by the at least two micro-antennas.

9. The system of claim 8, wherein the processing element is further adapted to control the direction of the RF signal transmission by adjusting the signal gain and relative phase angle of the RF signal transmitted by each of the at least two radio transmitter modules through the at least two micro-antennas.

10. The system of claim 3, wherein the one or more micro-antennas are integrated into a chip device package housing the processing element.

11. The system of claim 3, wherein the one or more micro-antennas are integrated into one or more printed circuit boards.

12. The system of claim 3, further comprising:
a controller element, and
a control channel, wherein the controller element is adapted to communicate configuration data with one or more of the plurality of processing elements through the control channel, wherein the one or more of the plurality of processing elements are further adapted to configure one or more reconfigurable wireless interconnects based on the configuration data.

13. The system of claim 3, wherein configuration data communicated to each of the one or more or the plurality of processing elements includes one or more of which processing elements of the one or more of the plurality of processing elements to transmit to, and which processing elements of the one or more of the plurality of processing elements to listen to.

14. The system of claim 13, wherein the control channel comprises communications channel including at least one of a serial data bus, parallel data bus, a fiber optic channel, and a wireless communications channel.

15. The system of claim 1 further comprising:
one or more wired processing elements adapted to communicate through a wired communications bus; and
one or more bridge elements adapted to the communicate with the one or more wired processing elements through the wired communication bus, wherein the one or more bridge elements are further adapted to communicate with at least one of the plurality of processing elements through at least one of the one or more reconfigurable wireless interconnects.

16. A reconfigurable processing system, the system comprising:
means for processing data with processing elements;
means for reconfigurable wireless interconnections between the processing elements.

17. The system of claim 16, wherein the means for reconfigurable wireless interconnections further comprises:
means for transmitting one or more RF signals representing processing data output; and
means for receiving one or more RF signals representing processing data input.

18. The system of claim 17, further comprising:
means for modulating the one or more RF signals representing processing data output based on a first data bit rate; and
means for demodulating the one or more RF signals representing processing data input based on a second data bit rate.

19. The system of claim 18, further comprising:
means for evaluating processing data output to determine the first data bit rate.

20. The system of claim 17, further comprising:
means for controlling the direction of an RF signal transmitted by the means for transmitting one or more RF signals.

21. A method for wireless data communication between processing elements, the method comprising:
modulating processing element data output;
transmitting one or more RF signals representing processing data output at a first data bit rate;
receiving one or more RF signals representing processing data input; and
demodulating the processing element data input.

22. The method of claim 21, wherein the processing elements include one or more of micro-processors, memory, digital signal processors, math co-processors, field-programmable gate arrays (FPGA), analog-to-digital (A/D) and digital-to-analog (D/A) converters.

23. The method of claim 21 further comprising:
determining a direction to transmit an RF signal; and
configuring transmitters to transmit an RF signal in the determined direction.

24. The method of claim 21 further comprising:
evaluating processing element data output to determine the first bit rate; and
configuring a radio transmitter to transmit at the first bit rate.

25. A processing element adapted to communicate to at least one other processing element through one or more reconfigurable wireless interconnects, the processing element comprising:
one or more micro-antennas;
one or more radio transmitter modules adapted to transmit one or more RF signals representing processing element data output, wherein the one or more radio transmitter modules are further adapted to modulate the processing element data output based on a first data link protocol; and
one or more radio receiver modules adapted to receive one or more RF signals representing processing element data input, wherein the one or more radio receiver modules are further adapted to demodulate the processing element data input based on a second data link protocol.

26. The processing element of claim 25, wherein the plurality of processing elements include at least one of micro-processors, memory, digital signal processors, math co-processors, field-programmable gate arrays (FPGA), analog-to-digital (A/D) and digital-to-analog (D/A) converters.

27. The processing element of claim 25, wherein the first data link protocol and the second data link protocol each include one or more of a data link bit-rate and a modulation protocol.

28. The processing element of claim 27, wherein each processing element of the plurality of processing elements further comprises:
a partitioning tool, wherein the partitioning tool is adapted to evaluate the processing element data output to determine the required data link bit-rate.

29. The processing element of claim 25, wherein the processing element is further adapted to control the direction of the RF signal transmission.

30. The processing element of claim 25, wherein the one or more micro-antennas are integrated into a device package housing the processing element.
